(19) United States
(12) Patent Application Publication
(10) Pub. No.: US 2006/0282378 A1
(43) Pub. Date: Dec. 14, 2006

(54) Real Estate Transaction Method And System

(76) Inventor: Bradley L. Gotfried, Hong Kong (HK)

Correspondence Address: AKERMAN SENTERFITT, P.O. BOX 3188, WEST PALM BEACH, FL, 33402-3188, US

(21) Appl. No.: 11/456,198

(22) Filed: Jul. 8, 2006

Related U.S. Application Data
(63) Continuation of application No. 09/718,997, filed on Nov. 22, 2000, now abandoned.

(51) Int. Cl. G06Q 40/00

(52) U.S. Cl. 705/39

(57) ABSTRACT

A method and system for brokering real estate transactions, in which a broker allows a user to sell a first property and purchase a second property via a computer communications network. The method and system include the following steps: (a) the broker accepting at least one first property sale offering; (b) the broker providing at least one second property purchase offering; (c) the broker allowing the user to accept a selection of at least one second property selected from the at least one second property purchase offering; (d) the broker transferring the sale proceeds from the sale transaction of the first property to the user, for use in purchasing the at least one second property selected in said accepting step (c); and (e) executing a purchase transaction of the at least one second property selected in said accepting step (c), using the sale proceeds from the sale transaction of the at least one first property as payment towards the purchase of the at least one second property.

### CROSS REFERENCE TO RELATED APPLICATIONS

This application is a continuation of U.S. patent application Ser. No. 09/718,997 filed on Nov. 22, 2000, the entirety of which is incorporated herein by reference.

### STATEMENT REGARDING FEDERALLY SPONSORED RESEARCH OR DEVELOPMENT

Not Applicable.

### BACKGROUND OF THE INVENTION

1. Technical Field

The present invention relates generally to a method and system for conducting real estate transactions. More particularly, the invention relates to a method and system for providing for the sale of one real estate holding and a purchase of another real estate holding.

2. Description of the Related Art

Buying and selling real estate can be complex and time consuming. Generally, a homeowner looking to relocate needs to sell the home in which the homeowner is currently living and, at approximately the same time, locate and purchase another home. Similarly, when all or a portion of a business needs to relocate, it is often necessary to sell all or a portion of the commercial real estate currently being occupied by the business, at approximately the same time the new commercial real estate is purchased. Both situations can be burdensome because most individuals and businesses do not have the financial resources to simultaneously own, or hold mortgages for, multiple homes or offices. Relocating can become even more difficult when an individual or business entity decides to relocate to an unfamiliar and/or distant geographical area. Under such circumstances, a homeowner typically needs two real estate agents, one to sell existing property in a current location and one to help locate new property in a destination location.

Numerous nationwide agencies are available to assist homeowners who are moving or relocating. Presently, such agencies can fulfill many needs such as job hunting and researching potentially new areas in which to live. Many of these relocation services can be accessed through the Internet. For example, a potential homeowner can log onto the Internet, visit a relocation service web site and search for new homes, schools and employment. Notwithstanding the convenience of the presently available services, however, there remains a need to simplify the buying and selling of residential and commercial real estate.

### SUMMARY OF THE INVENTION

According to one embodiment, the present invention relates to a method and system for brokering real estate transactions, in which a broker allows a user to sell a first property and purchase a second property via a computer communications network. This embodiment of the invention includes the following steps: (a) the broker accepting at least one first property sale offering; (b) the broker providing at least one second property purchase offering; (c) the broker allowing the user to accept a selection of at least one second property selected from the at least one second property purchase offering; (d) the broker transferring the sale proceeds from the sale transaction of the first property to the user, for use in purchasing the at least one second property selected in said accepting step (c); and (e) executing a purchase transaction of the at least one second property selected in said accepting step (c), using the sale proceeds from the sale transaction of the at least one first property as payment towards the purchase of the at least one second property.

In another arrangement, the invention relates to a machine readable storage, having stored thereon a computer program having a plurality of code sections executable by a machine for causing the machine to conduct real estate transactions wherein a broker allows a user to sell a first property and purchase a second property via a computer communications network. This arrangement includes the following steps: (a) accepting at least one first property sale offering;
(b) providing at least one second property purchase offering; (c) accepting a selection of at least one second property selected from the at least one second property purchase offering; (d) transferring the sale proceeds from the sale transaction of the first property for use in purchasing the at least one second property selected in said accepting step (c); and (e) executing a purchase transaction of the at least one second property selected in said accepting step (c), using the sale proceeds from the sale transaction of the at least one first property as payment towards the purchase of the at least one second property.

In either arrangement, the sale proceeds can be transferred into an escrow account. Additionally, the first property offering step can include executing a sale transaction of the first property offering, in which the broker purchases the first property offering from the user. The purchase execution step (e) can include the use of electronic encryption, such as the Secure Sockets Layer encryption standard. In addition, the first property offering step can include the use of electronic encryption, such as the Secure Sockets Layer encryption standard.

The first property offering step (a) can include querying the user for information regarding the property offering, such as search criteria to be used to identify the at least one second property. The search criteria relating to the at least one second property can be one or more of the following: location, price, interior area, exterior area, number of bedrooms, number of bathrooms, liens and other encumbrances, date of construction, and the distance between the first property and at least one of schools, medical and rescue services, religious organizations, restaurants, shopping areas, and mass transit services.

In either arrangement, the purchase execution step (e) and/or the first property offering step (a) can utilize digital signature technology for transaction consummation. Accordingly, the querying step can include ascertaining from the user whether the user has a digital signature and/or registering the digital signature of the user.

According to the invention, the first property offering step (a) can include processing by a network server. The network server processing can include receiving information from the user regarding the first property, and/or formulating queries for use with at least one public record database. The public record database queries can be formulated to ascertain information regarding title status and/or taxable value of the first real property. The network server processing can include executing the public record database queries via a computer communications network, and/or obtaining results from the public record database queries via a computer communications network.

The results of the public record database queries can be compiled into a results report, and the results report can be transmitted to the user. Either transmission can occur via a computer communications network.

The invention can also include the step of allowing the user to confirm the sale transaction step prior to execution of the transaction. The confirming step can further include providing the user with a proposed purchase price for the at least one first property. The proposed purchase price can be the taxable value of the at least one first property. The proposed purchase price can instead be the taxable value of the first property multiplied by a pricing factor. The confirming step can include allowing the user to accept or reject the proposed purchase price.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 is a schematic representation of computer architecture suitable for use with the present invention.

FIG. 2 is a schematic of a server suitable for use with the present invention.

FIG. 3 is a schematic of a fixed storage device suitable for use with the present invention.

FIGS. 4A-4H are screens showing an embodiment of the present invention.

FIG. 5 is a flow diagram showing an embodiment of the present invention.

### DETAILED DESCRIPTION OF THE INVENTION

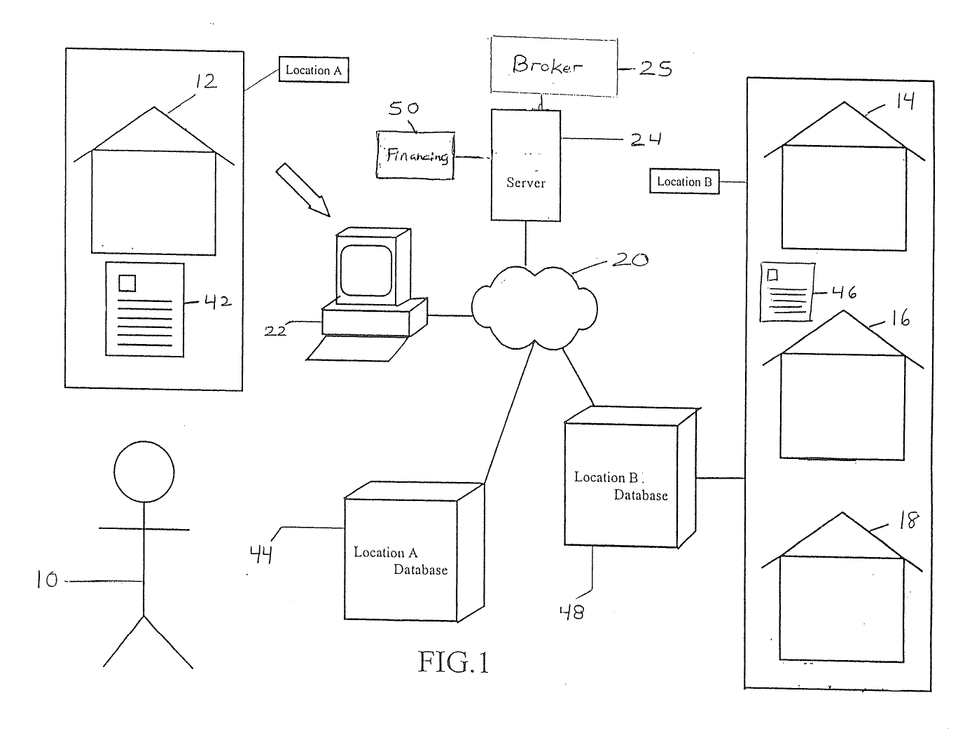

The present invention relates to a method and system for conducting real estate transactions. The invention can be used in connection with any type of real estate, such as residential or commercial real estate. Referring to FIG. 1, the invention allows a user 10, such as an individual or entity, to sell a first property 12 and purchase a second property 14, 16, 18 via a computer communications network 20. The computer communications network 20 can be, but is not limited to, any privately or publicly accessible network. For example, the privately and publicly accessible networks can include any number or combination of the following: local area networks, wide area networks, metropolitan area networks, and global area networks. The Internet and Bitnet are examples of global area networks. Examples of privately accessible networks include America Online®, Compuserve®, and Prodigy®. It is understood that the invention is not limited to any of these examples, as any other computer communications network is also within the scope of the invention. Thus, any computer communications network 20 arrangement can be used to perform transactions or other steps according to the invention.

The user 10 can use a computer 22 or any other device suitable to connect to the computer communications network 20, in order to access a relocation web server 24. Access to the server 24 allows the user 10 to view information located in or associated with the server 24. For example, if the computer communications network 20 is the Internet, accessing the server 24 can allow the user 10 to access one or more Web pages in or associated with the server 24. The server 24 can be operated by a broker 25. The broker 25 can be any suitable individual or entity, such as a real estate broker, agent or corporation.

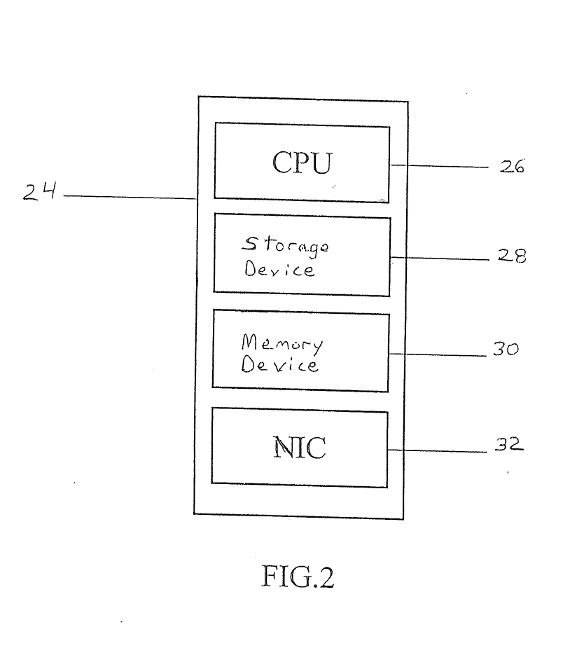

FIG. 2 shows an example of the server 24 which is suitable for use with the present invention. The server 24 can be include a central processing unit (CPU) 26, a fixed storage device 28 such as a hard disk drive (HDD), and an internal memory device 30 such as random access memory (RAM). The server 24 can also include a network interface card (NIC) 32 for connecting the server 24 to the computer communications network 20. Additionally, any suitable input structure such as a keyboard or mouse and any suitable display structure such as a monitor or printer can be connected to or in communication with the server 24 in any suitable manner. It is understood, however, that the present invention does not require such input or display structure.

For security purposes, the server 24 can utilize encryption technology, particularly in those transactions involving the actual transfer of real property. In one arrangement, the server 24 can implement the Secure Sockets Layer encryption standard to protect the integrity of the transactions being conducted during the relocation process. The Secure Sockets Layer encryption standard can provide data encryption, server authentication, message integrity, and client authentication. It is understood, however, that the invention is not limited to use of the Secure Sockets Layer Encryption Standard, as any encryption system is acceptable.

The server 24 can also employ digital signature technology to ensure that the completed transactions are binding contracts. In one arrangement, the invention can use public key cryptography to enable the server 24 to recognize and accept authentic electronic signatures. It is understood, however, that the invention is not limited in this regard, as any digital signature technology may be used for generating digital signatures. In the event that a user has not yet established a digital signature, the server 24 can provide software that enables the user to create and register a digital signature that can be used to consummate transactions, such as real property transactions.

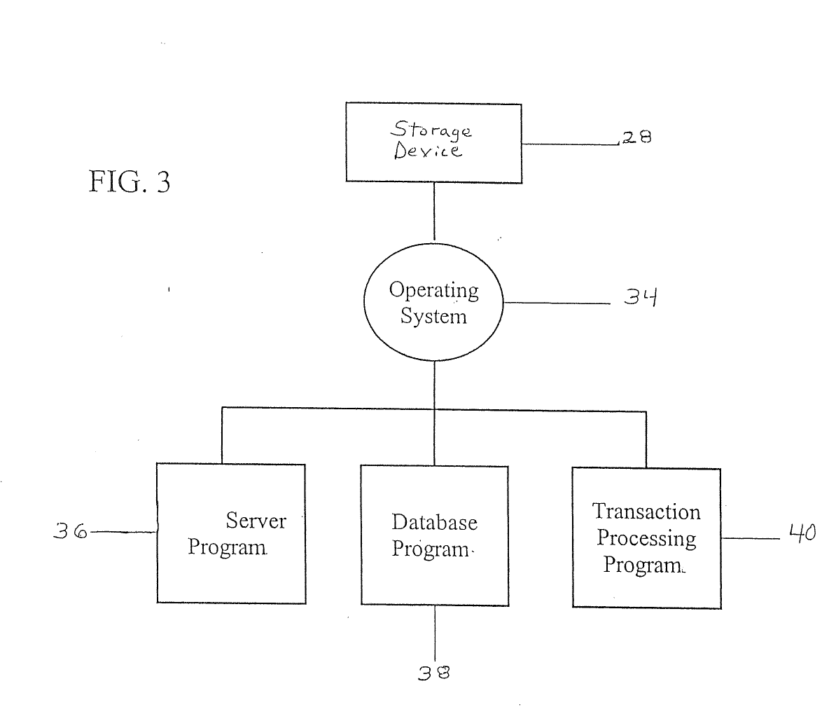

As shown in FIG. 3, the storage device 28 can include an operating system 34. The storage device 28 can also store computer programs, such as at least one server program 36, at least one database program 38, and at least one transaction processing program 40. The server program 36, the database program 38, and the transaction processing program 40 can assist the broker 25 with conducting real estate transactions via the computer communications network 20. The server program 36 can be any program suitable for receiving information from and/or providing information to the computer communications network 20. For example, if the computer communications network 20 is the Internet, the server program 36 can be a program suitable for hosting Web pages and providing Web content via the Internet. The database program 38 can, for example, store information gathered by the server 24 to be used by the transaction processing program 40. In an alternative arrangement, the database program 38 can be a public records database accessible through the computer communications network 20. The transaction processing program 40 can be an application that can consummate real estate transactions.

In the configuration of FIG. 1, a user 10 owns at least one first property 12 in location A. The user 10 is interested in selling the first property 12, and using the proceeds from the sale of the first property 12 to purchase a second property 14, 16, 18 in location B. The user 10 can provide the server 24 with information 42 about the first property 12. For example, the information 42 about the first property 12 can be its location, price, interior area, exterior area, number of bedrooms, and/or number of bathrooms. The information 42 can also include liens, mortgages, or other encumbrances relating to the first property 12, or the date of construction of the first property 12. In yet another example, the information 42 can indicate the distance between the first property 12 and at least one of the following: schools, medical and rescue services, religious organizations, restaurants, shopping areas, and mass transit services. It is understood that the invention is not limited to the aforementioned examples, as the information 42 can be any data relating to the first property 12.

The server 24 can connect through the computer communications network 20 to a communicatively connected Location A Database 44. The Location A Database 44 can be used by the broker 25 to verify the information 42 provided by the user 10 and to ascertain a value for the first property 12. In one arrangement, the Location A Database 44 can be a public records database, preferably accessible through the computer communications network 20. It is understood that privately owned databases can also be searched to verify user-provided information and to obtain a value for the first property 12. Using the information gathered from the Location A Database 44, the broker 25 can calculate a price to offer the user 10 in exchange for the first property 12. The offer price can be calculated in any suitable manner. For example, the purchase price can be a verifiable value, such as the taxable value of the first property 12. In another arrangement, the purchase price can be the taxable value of the first property 12 multiplied by a pricing factor. This pricing factor can be used to adjust the purchase price to reflect the actual market value of the first property 12, as the taxable value of a property is often less than its market value. It is understood that the invention is not limited to the aforementioned methods of calculating an offer price for the first property 12, as any other suitable value or formula may be used to calculate the offer price.

Once an offer price for the first property 12 is determined, the broker 25 can provide that offer price to the user 10 via the computer communications network 20. If the user 10 deems the offer price to be acceptable, the user 10 can accept the offer price for the first property 12, and use the proceeds from the sale of the first property 12 towards the purchase of a second property 14, 16, 18 at Location B. In one arrangement, the broker 25 can place the proceeds from the sale of the first property 12 into an escrow account.

Prior to or after the broker 25 purchases the first property 12, the user 10 can provide to the server 24 information 46 regarding one or more second properties 14, 16, 18 which the user 10 is interested in purchasing. For example, the information 46 about the second property 14, 16, 18 can be its location, price, interior area, exterior area, number of bedrooms, and/or number of bathrooms. The information 46 can also include liens, mortgages, or other encumbrances relating to the second property 14, 16, 18, or the date of construction of the second property 14, 16, 18. In yet another example, the information 46 can indicate the distance between the second property 14, 16, 18 and at least one of the following: schools, medical and rescue services, religious organizations, restaurants, shopping areas, and mass transit services. It is understood that the invention is not limited to the aforementioned examples, as the information 46 can be any data relating to the second property 14, 16, 18. It is also understood that the information 46 can include data regarding a single second property 14, 16, 18, or a plurality of second properties 14, 16, 18.

The server 24 can connect via the computer communications network 20 to a Location B Database 48, and query the Location B Database 48 for available properties in Location B which meet the criteria provided by the user 10 regarding the second property 14, 16, 18. The second properties 14, 16, 18 which meet the criteria can be presented in any suitable manner. For example, if the computer communications network is the Internet, the second properties 14, 16, 18 can be presented in a Web page associated with or on the server 25. The user 10 can browse the available second properties 14, 16, 18, and select a second property 14, 16, 18 to purchase. The user 10 can arrange financing from at least one financing entity or individual 50 in order to obtain funds for use in purchasing the second property 14, 16, 18, particularly where the purchase price of the second property 14, 16, 18 exceeds the sale price of the first property 12. The user 10 can also obtain financing from the financing entity or individual 50 for other moving or relocation expenses.

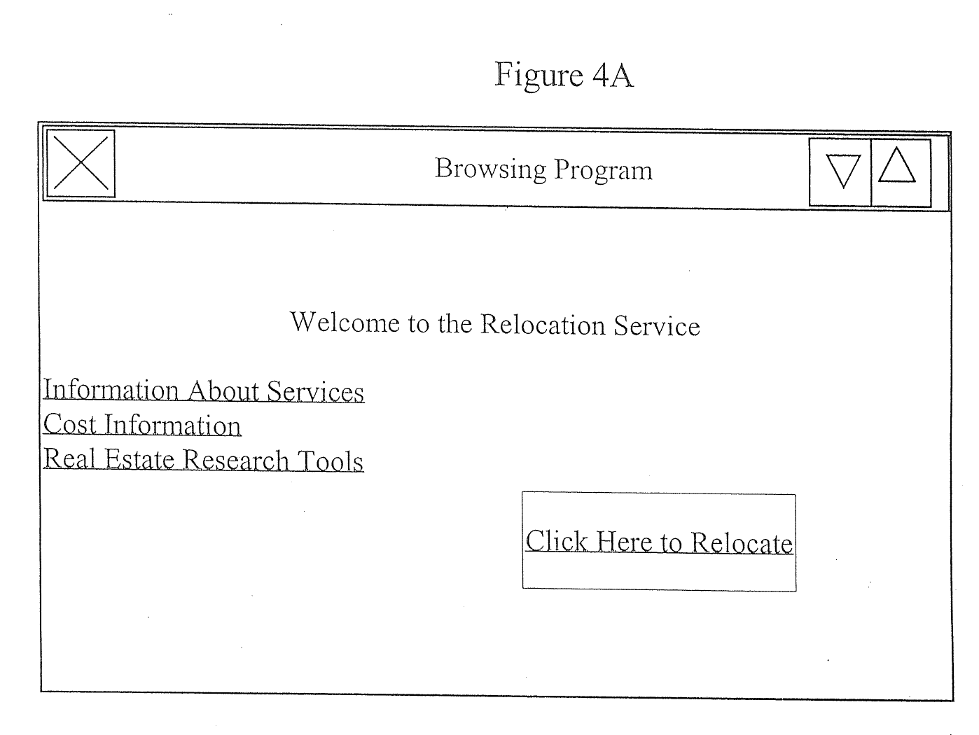

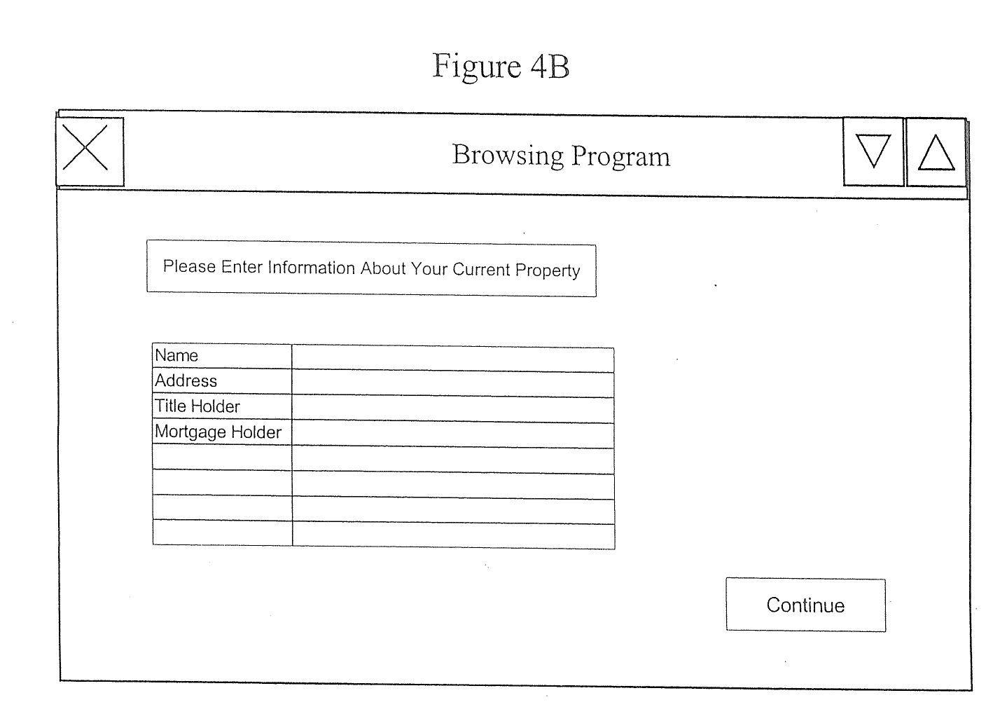

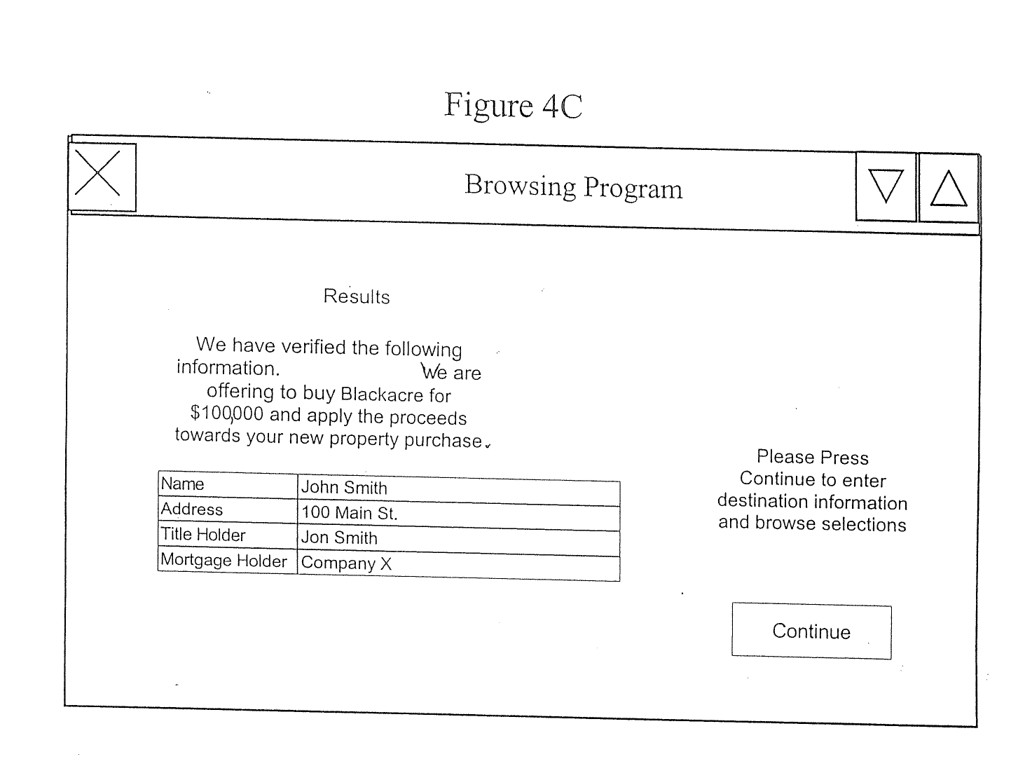

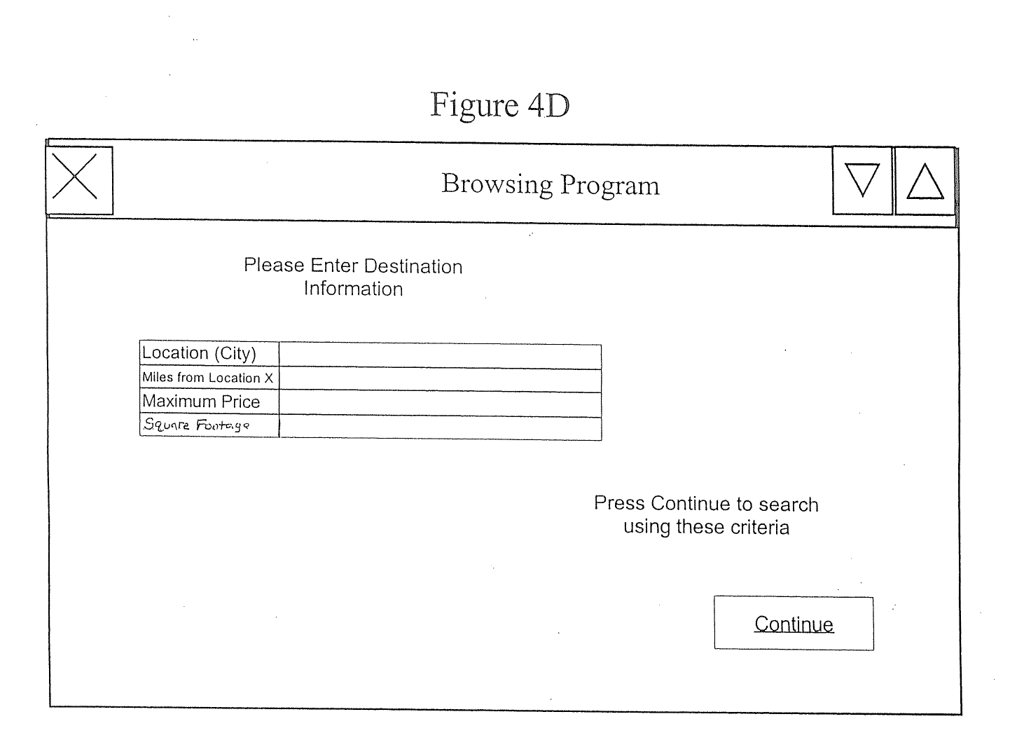

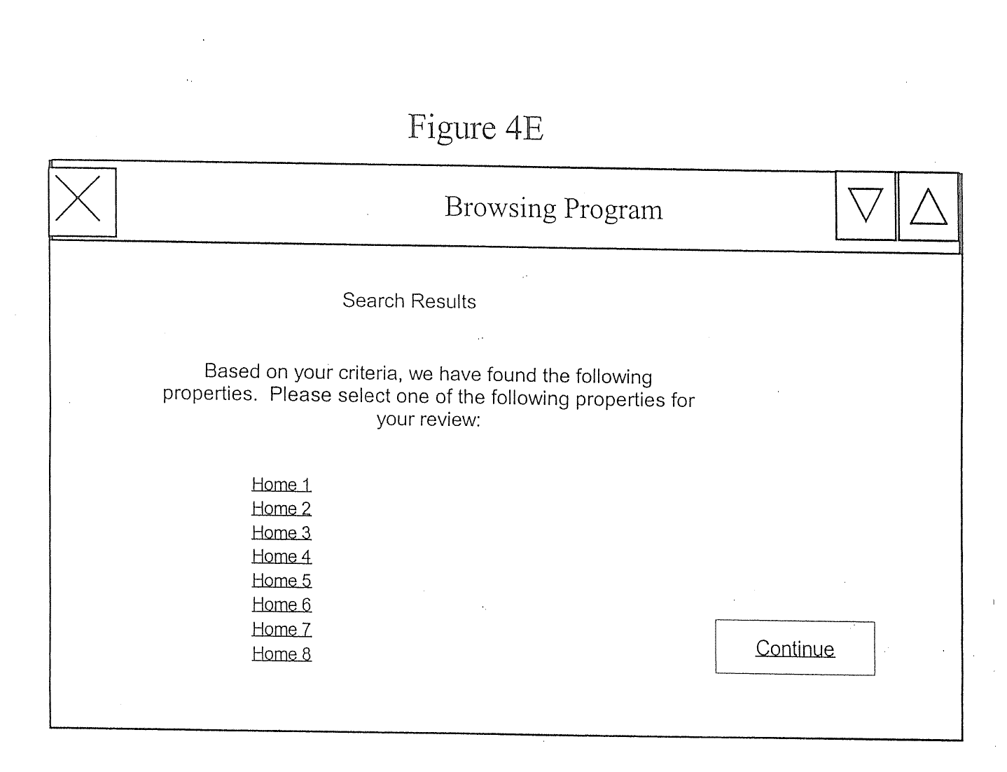

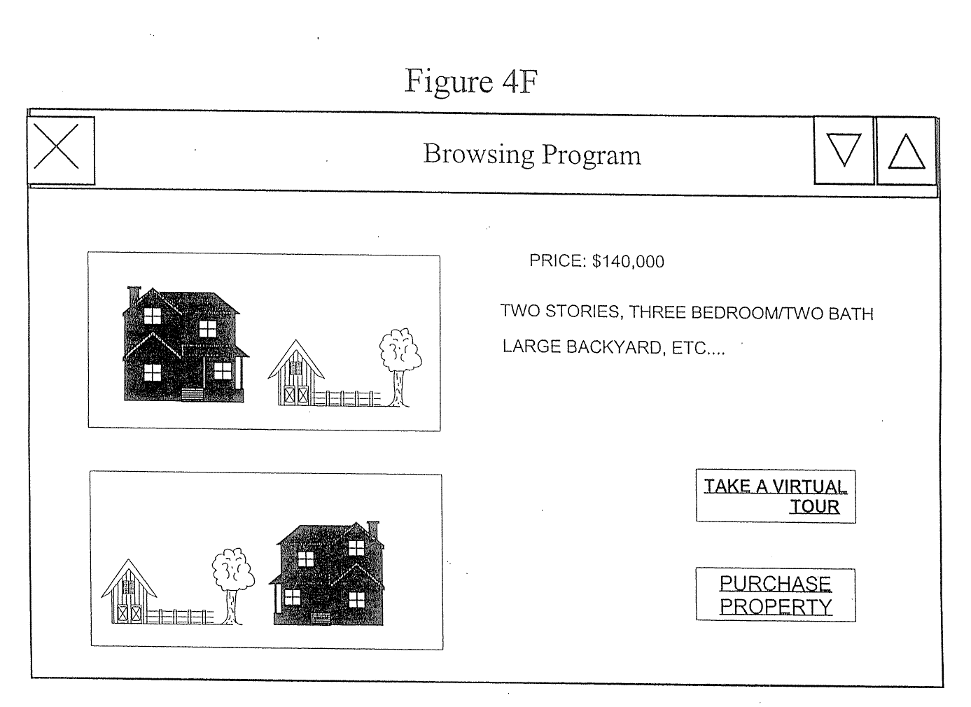

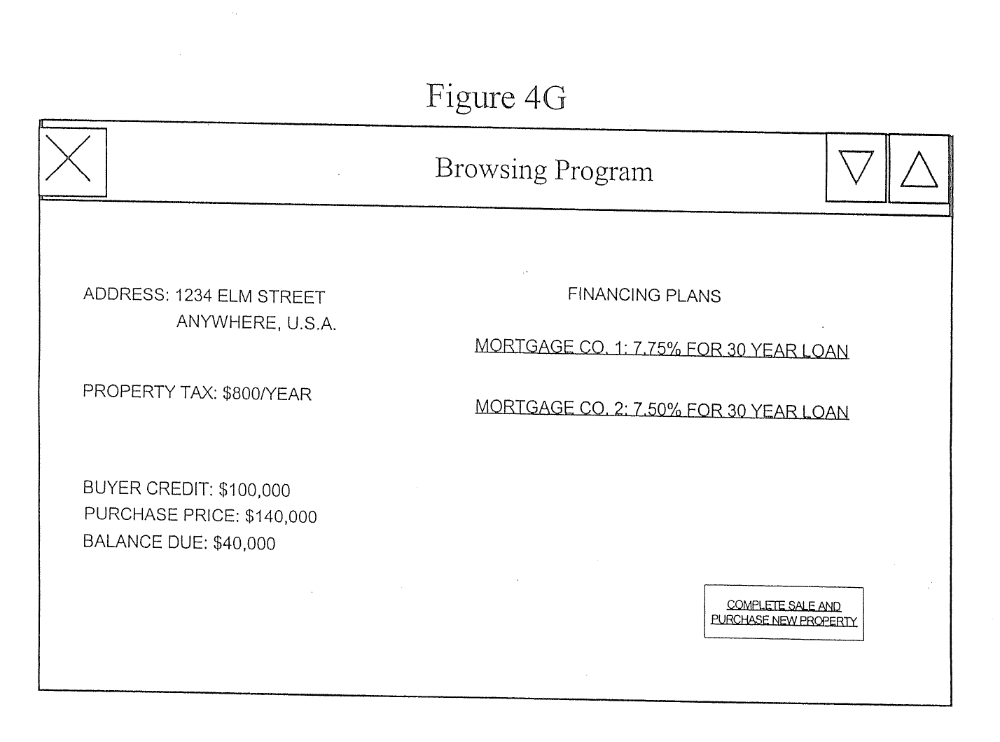

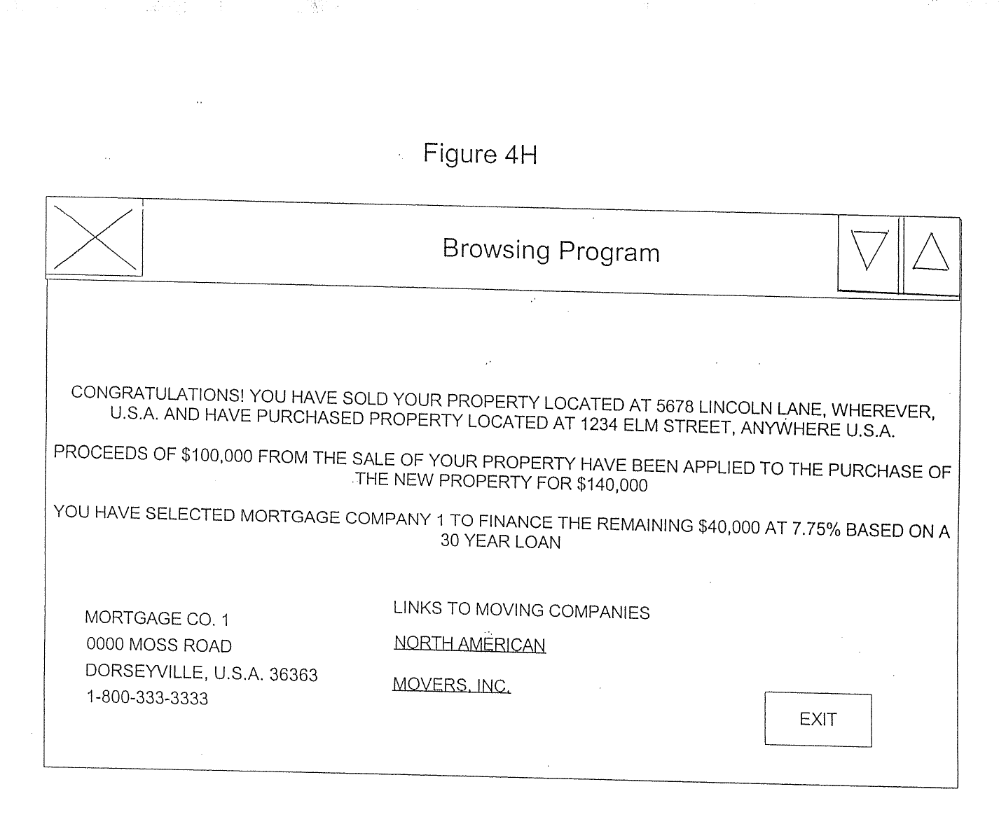

The screen shots of FIGS. 4A-4H show an example of a transaction according to the invention, in which a first property 12 will be sold and a second property 14, 16, 18 will be purchased, and the proceeds from the sale of the first property 12 can be used to purchase the second property 14, 16, 18. In the example of FIGS. 4A-4H, the computer communications network 20 is the Internet and the screen shots are web pages as provided by the server 24, although the invention is not limited in this regard. It is also understood that FIGS. 4A-4H represent merely one example of the invention, as the invention is not limited to the sequence of steps presented in FIGS. 4A-4H, or the information contained or transactions described therein.

FIG. 4A shows an example of a welcome screen containing information about real estate transaction services available to the user 10. As shown in FIG. 4A, such information can include, but is not limited to, an overview of the transactional process, cost information, and real estate research tools. Additionally, a link for initiating a transaction is provided. In the example of FIG. 4A, the link is in the form of a hyperlink with the caption “Click Here to Relocate.” The link can take on many other embodiments and/or have a plurality of captions. Once selected, the link can direct the user 10 to the screen shown in FIG. 4B.

In particular, FIG. 4B shows a plurality of data entry fields into which the user 10 can enter information 42 about the first property 12. Examples of acceptable data entry fields are the name of the user 10, the address of the first property 12, data relating to the title of the first property 12, and data relating to any mortgages which exist for the first property 12. After the user 10 enters required and/or optional information 42 into the data entry fields, a link can be selected to send the information 42 to the server 24 for processing. In the example of FIG. 4B, the link for sending the information 42 relating to the first property 12 is designated by the word “Continue.”

The server 24 can verify this information 42 through the database program 38. Prior to or after verification is completed, the server 24 can provide the user 10 with an offer price for the first property 12. The offer price can be determined by the transaction processing program 40.

FIG. 4C shows a sample sales response screen for use with the present invention. Information on the sales response screen can include, but is not limited to, the purchase price offered for the first property 12, and the results of a title search and a mortgage analysis for the first property 12. Once the user 10 has reviewed the sales response screen, the user 10 can select a link to a screen which allows the user 10 to enter information 46 regarding the type of second property 14, 16, 18 the user 10 is interested in purchasing. In FIG. 4C, this link is designated by the word “Continue.”

FIG. 4D shows a sample screen which queries the user 10 for information 46 relating to the type of second property 14, 16, 18 the user 10 is interested in purchasing. Any number of search fields and any type of search field is acceptable. The user 10 can be presented with a plurality of search fields into which the information 46 can be entered. For example, as shown in FIG. 4D, the search fields can include the location of the second property 14, 16, 18, the distance between the second property 14, 16, 18 and another location, the maximum price that the user 10 will pay for the second property 14, 16, 18, and the area of the second property 14, 16, 18.

The user 10 can provide data into any number of search fields, and can limit search parameters to one or more particular fields. Once the user 10 has entered the information 46, a link can be selected to send the information 46 to the server 24 for processing. The server 24 can then search for second properties 14, 16, 18 which match identically or closely match all or a portion of the information 46. The search for the second properties 14, 16, 18 can be performed using the database program 38. For example, the server 24 can retrieve from the database program 38 available properties located in a particular geographic location. Second properties 14, 16, 18 identified by the search can be presented to the user 10.

FIG. 4E is an example of a screen showing the results of a search for second properties 14, 16, 18. The user 10 can review the results of the search, and select one or more links associated with the second properties 14, 16, 18 identified by the search. Selecting such a link can allow the user 10 to be provided with more detailed information regarding the selected second property 14, 16, 18.

FIG. 4F shows a screen in which more detailed information is provided regarding a second property 14, 16, 18 identified by the search and selected by the user 10. The detailed information can be provided by the server 24 from the Location B Database 48. In the example of FIG. 4F, the detailed information regarding the second property 14, 16, 18 includes a physical description, a selling price, and photographs. The example of FIG. 4F also shows a link which allows the user 10 to take a “virtual tour” of the second property 14, 16, 18. During such a tour, the user 10 can be provided with images of the interior of the second property 14, 16, 18. The images can be arranged so that the user 10 can be provided with as much as a three hundred sixty degree view from a particular location of the second property 14, 16, 18. If the user 10 wishes to purchase the second property 14, 16, 18, the user 10 can select the “Purchase Property” link of FIG. 4F to initiate the purchase of the second property 14, 16, 18. A decision to purchase the second property 14, 16, 18 can be transmitted to the server 24.

The transaction processing program 40 can be used to process information relating to the request by the user 10 to purchase the second property 14, 16, 18. The results of the processing by the transaction program 40 can be provided to the user 10.

FIG. 4G shows an example of a screen displaying transaction information relating to the second property 14, 16, 18. The transaction information can include any balance remaining from the proceeds of the sale of the first property 12 or the amount owed by the user 10 to complete the purchase of the second property 14, 16, 18. The transaction information can also include a mortgage analysis from one or more financing entities or individuals 50, such as where the proceeds from the sale of the first property 12 are less than the sale price of the second property 14, 16, 18. Other data, such as property tax information, can also be displayed. It is understood that the foregoing examples merely represent a portion of the analysis that the transaction program 33 can perform and is not meant to convey the full potential of such a program.

If the user 10 is satisfied with the transaction information, the user 10 can select a financing plan, if necessary, and can select a link to complete the transaction. As an example, the user 10 can select the financing plan offered by mortgage company 1, and then select the “Complete Sale and Purchase New Property” link shown in FIG. 4G. The request can then be verified using a digital signature and/or any other means for conducting a secure transaction via a computer communications network, such as the Secure Sockets Layer encryption standard.

Once the transaction is completed, the user 10 can receive a confirmation. The sample confirmation shown in FIG. 4H contains an overview of the first property 12 sold by the user 10 and the second property 14, 16, 18 purchased by the user 10. Additionally, the confirmation screen can include financial information, mortgage contact information and links to other services such as moving companies, although the information displayed on the confirmation screen is not limited in this regard.

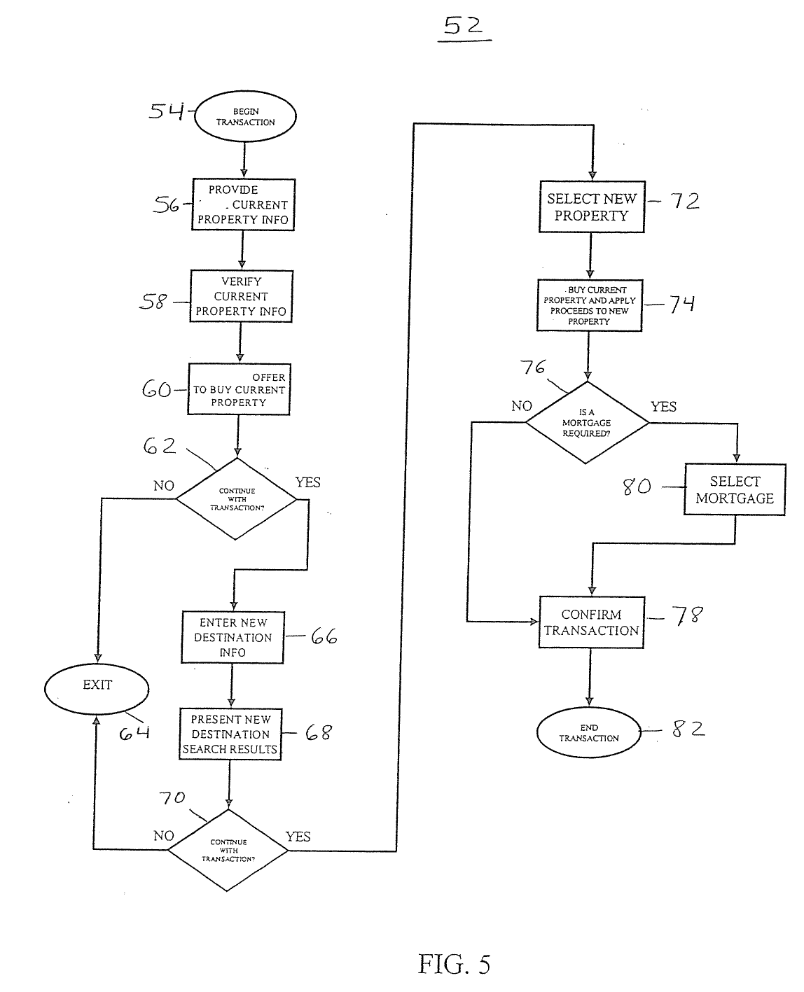

FIG. 5 provides a flow diagram 52 showing a transaction according to the present invention. It is understood that the flow diagram provides only an example transaction. Accordingly, the invention is not limited to the sequence of steps shown in the flow diagram 52, and does not require each step shown in the flow diagram 52.

Referring to FIG. 5, at step 54, the user 10 can begin a transaction in which a first property 12 will be sold and a second property 14, 16, 18 will be purchased, where the proceeds from the sale of the first property 12 can be used to purchase the second property 14, 16, 18. The transaction can begin by connecting to the server 24. At step 56, the user 10 can provide to the broker 25 information associated with the first property 12. The accuracy of the information provided by the user 10 to the broker 25 can be verified by the broker 25, as shown in step 58. In accordance with step 60, the broker 25 can offer to buy the first property 12.

At step 62, if the user 10 is not satisfied with the amount of the offer, the user 10 can stop the transaction at step 64. In contrast, if the user 10 is satisfied with the offer, the transaction can continue. In this regard, the user 10 can provide data regarding the type of second property 14, 16, 18 in which the user 10 is interested, according to step 66. At step 68, the user 10 can be presented with the results of the search for second properties 14, 16, 18. Referring to step 70, if the search does not identify any second properties 14, 16, 18, the user 10 can proceed to step 64 and stop the transaction. If the transaction is stopped, the offer by the broker 25 at step 60 can be rescinded. If the user 10 is presented with a second property 14, 16, 18 that the user 10 wants to purchase, the transaction can continue, and the user 10 can select a second property 14, 16, 18, as shown at step 72.

In accordance with step 74, the broker 25 can purchase the first property 12 from the user, and apply the proceeds from that purchase to the purchase of the second property 14, 16, 18. As shown at step 76, if the proceeds from the sale of the first property 12 are sufficient to cover the cost of the second property 14, 16, 18, the user 10 can receive a confirmation of the transaction at step 78. Alternatively, if the user 10 requires financing such as a mortgage to complete the purchase of the second property 14, 16, 18, the user 10 can be presented with several different financing options at step 80. If the user 10 selects a financing option or contributes his own finances to meet the purchase price, then the transaction can be confirmed at step 78. Once the transaction is confirmed, the process can end as shown at step 82.

It should be understood that the examples and embodiments described herein are for illustrative purposes only and that various modifications or changes in light thereof will be obvious to persons skilled in the art and are to be included within the spirit and purview of this application. Moreover, the invention can take other specific forms without departing from the spirit or essential attributes thereof.

What is claimed is:

1. A method for brokering real estate transactions wherein a broker allows a user to sell a first property and purchase a second property via a computer communications network, comprising the steps of:
(a) the broker purchasing a first property from the user;
(b) the broker providing at least one second property purchase offering;
(c) the broker receiving a selection of at least one second property selected from the at least one second property purchase offering;
(d) the broker transferring the sale proceeds from the sale transaction of the first property to the user, for use in purchasing the at least one second property selected in said receiving step (c); and
(e) executing a purchase transaction of the at least one second property selected in said receiving step (c), using the sale proceeds from the sale transaction of the at least one first property as payment towards the purchase of the at least one second property.

2. The method according to claim 1, wherein the broker's purchase of the first property is conditioned upon the user applying the sale proceeds from the sale transaction of the first property to purchase the second property.

3. The method according to claim 1, wherein said purchase execution step (e) further comprises the use of electronic encryption.

4. The method according to claim 3, wherein the electronic encryption utilizes the Secure Sockets Layer encryption standard.

5. The method according to claim 1, further comprising the step of the broker offering to the user a purchase price for the first property.

6. The method according to claim 5, wherein the purchase price of the first property is based on at least one selected from the group consisting of information regarding the first property received from the user, information regarding the first property contained in public records, the taxable value of the first property, and a combination thereof.

7. The method according to claim 1, wherein said first property offering step (a) further comprises querying the user for information regarding the property offering.

8. The method according to claim 7, wherein said querying step further comprises requesting information from the user regarding search criteria to be used to identify the at least one second property.

9. The method according to claim 8, wherein the search criteria relating to the at least one second property includes at least one of location, price, interior area, exterior area, number of bedrooms, number of bathrooms, liens and other encumbrances, date of construction, and the distance between the second property and at least one of schools, medical and rescue services, religious organizations, restaurants, shopping areas, and mass transit services.

10. The method according to claim 1, wherein said purchase execution step (e) further comprises the use of digital signature technology for transaction consummation.

11. The method according to claim 2, wherein said first property offering step (a) further comprises the use of digital signature technology for transaction consummation.

12. The method according to claim 7, wherein said querying step further comprises ascertaining from the user whether the user has a digital signature.

13. The method of claim 12, further comprising the step of registering the digital signature of the user.

14. The method according to claim 1, wherein said first property offering step (a) further comprises processing by a network server.

15. The method according to claim 14, wherein the network server processing further comprises the step of receiving information from the user regarding the first property.

16. The method according to claim 14, wherein the network server processing further comprises the step of formulating queries for use with at least one public record database.

17. The method according to claim 16, wherein said public record database queries are formulated to ascertain information regarding at least one of title status and taxable value of the first real property.

18. The method according to claim 14, wherein said network server processing further comprises the step of executing the public record database queries via a computer communications network.

19. The method according to claim 14, wherein said network server processing further comprises the step of obtaining results from the public record database queries via a computer communications network.

20. The method according to claim 14, wherein said network server processing further comprises the step of compiling the results of the public record database queries into a results report.

21. The method according to claim 14, wherein said network server processing step further comprises transmitting the results report to the user.

22. The method according to claim 21, wherein said transmitting step occurs via a computer communications network.

23. The method according to claim 2, further comprising the step of allowing the user to confirm the sale transaction step prior to execution.

24. The method according to claim 23, wherein said confirming step further comprises providing the user with a proposed purchase price for the at least one first property.

25. The method according to claim 24, wherein the proposed purchase price is the taxable value of the at least one first property.

26. The method according to claim 21, wherein the proposed purchase price is the taxable value of the first property multiplied by a pricing factor.

27. The method according to claim 24, wherein said confirming step further comprises allowing the user to accept or reject the proposed purchase price.

28. The method according to claim 1, wherein the sale proceeds are transferred into an escrow account.

29. A machine readable storage, having stored thereon a computer program having a plurality of code sections executable by a machine for causing the machine to conduct real estate transactions wherein a broker allows a user to sell a first property and purchase a second property via a computer communications network, comprising the steps of:
(a) purchasing a first property from the user;
(b) providing at least one second property purchase offering;
(c) receiving a selection of at least one second property selected from the at least one second property purchase offering;
(d) transferring the sale proceeds from the sale transaction of the first property for use in purchasing the at least one second property selected in said receiving step (c); and
(e) executing a purchase transaction of the at least one second property selected in said receiving step (c), using the sale proceeds from the sale transaction of the at least one first property as payment towards the purchase of the at least one second property.

30. The machine readable storage according to claim 29, wherein the purchasing of the first property is conditioned upon the user applying the sale proceeds from the sale transaction of the first property to purchase the second property.

31. The machine readable storage according to claim 29, wherein said purchase execution step (e) further comprises the use of electronic encryption.

32. The machine readable storage according to claim 31, wherein the electronic encryption utilizes the Secure Sockets Layer encryption standard.

33. The machine readable storage according to claim 29, further comprising the step of offering to the user a purchase price of the first property.

34. The machine readable storage according to claim 33, wherein the purchase price of the first property is based on at least one selected from the group consisting of information regarding the first property received from the user, information regarding the first property contained in the public records, the taxable value of the first property, and a combination thereof.

35. The machine readable storage according to claim 29, wherein said first property offering step (a) further comprises querying the user for information regarding the property offering.

36. The machine readable storage according to claim 35, wherein said querying step further comprises requesting information from the user regarding search criteria to be used to identify the at least one second property.

37. The machine readable storage according to claim 36, wherein the search criteria relating to the at least one second property includes at least one of location, price, interior area, exterior area, number of bedrooms, number of bathrooms, liens and other encumbrances, date of construction, and the distance between the second property and at least one of schools, medical and rescue services, religious organizations, restaurants, shopping areas, and mass transit services.

38. The machine readable storage according to claim 29, wherein said purchase execution step (e) further comprises the use of digital signature technology for transaction consummation.

39. The machine readable storage according to claim 30, wherein said first property offering step (a) further comprises the use of digital signature technology for transaction consummation.

40. The machine readable storage according to claim 35, wherein said querying step further comprises ascertaining from the user whether the user has a digital signature.

41. The machine readable storage according to claim 40, further comprising the step of registering the digital signature of the user.

42. The machine readable storage according to claim 29, wherein said first property offering step (a) further comprises processing by a network server.

43. The machine readable storage according to claim 42, wherein the network server processing further comprises the step of receiving information from the user regarding the first property.

44. The machine readable storage according to claim 42, wherein the network server processing further comprises the step of formulating queries for use with at least one public record database.

45. The machine readable storage according to claim 44, wherein said public record database queries are formulated to ascertain information regarding at least one title status and taxable value of the first real property.

46. The machine readable storage according to claim 42, wherein said network server processing further comprises the step of executing the public record database queries via a computer communications network.

47. The machine readable storage according to claim 42, wherein said network server processing further comprises the step of obtaining results from the public record database queries via a computer communications network.

48. The machine readable storage according to claim 42, wherein said network server processing further comprises the step of compiling the results of the public record database queries into a results report.

49. The machine readable storage according to claim 42, wherein said network server processing step further comprises transmitting the results report to the user.

50. The machine readable storage according to claim 49, wherein said transmitting step occurs via a computer communications network.

51. The machine readable storage according to claim 30, further comprising the step of allowing the user to confirm the sale transaction step prior to execution.

52. The machine readable storage according to claim 51, wherein said confirming step further comprises providing the user with a proposed purchase price for the at least one first property.

53. The machine readable storage according to claim 52, wherein the proposed purchase price is the taxable value of the at least one first property.

54. The machine readable storage according to claim 49, wherein the proposed purchase price is the taxable value of the first property multiplied by a pricing factor.

55. The machine readable storage according to claim 52, wherein said confirming step further comprises allowing the user to accept or reject the proposed purchase price.

56. The machine readable storage according to claim 29, wherein the sale proceeds are transferred into an escrow account.
